(19) United States
(12) Patent Application Publication
(10) Pub. No.: US 2015/0022463 A1
(43) Pub. Date: Jan. 22, 2015

(54) SYNCHRONIZATION OF INPUT SURFACE DATA AND DISPLAY SCREEN REFRESH

(71) Applicant: Lenovo (Singapore) Pte. Ltd., Singapore (SG)

(72) Inventors: Scott Edwards Kelso, Cary, NC (US); Toby John Bowen, Durham, NC (US); Robert A. Bowser, Cary, NC (US); Matthew Lloyd Hagenbuch, Durham, NC (US)

(21) Appl. No.: 13/944,454

(22) Filed: Jul. 17, 2013

(51) Int. Cl. G06F 3/041

(52) U.S. Cl. CPC G06F 3/041
USPC 345/173

(57) ABSTRACT

An aspect provides a method, including: providing an indication of display screen refresh timing derived from a display system; associating, using the indication of the display screen refresh timing, a set of input data derived from an input surface with a display screen refresh interval; and synchronizing, using one or more processors, the set of input data derived from the input surface with a refresh of a display screen. Other aspects are described and claimed.

### BACKGROUND

Information handling devices (“devices”), for example cell phones, smart phones, tablet devices, laptop and desktop computers, televisions, alarm clocks, navigation systems, e-readers, etc., employ one or more input devices. Among these input devices are input surfaces such as a touch sensitive input surface, for example touch screens, digitizers and touch pads.

Input surfaces such as digitizers and touch screens continually record the location of a stylus pointer or finger (relative to the input surface). This location information may be reported to the system, e.g., typically the operating system (OS) uses this location information to render some visual effect based on the location information. Any lags or inconsistency of motion (between the input provided by the user and the interpretation and rendering thereof by the OS) breaks the illusion of responsiveness. Such inconsistencies may cause the user to try to compensate (e.g., by modifying the input provided) or simply frustrate the user.

Sensing, interpreting and rendering within one display screen refresh period creates a beneficial user experience. Achieving all these actions in one screen refresh period is challenging, however, e.g., because screen refresh periods are short (on the order of 17 ms for a liquid crystal display (LCD)). In conventional systems it is not uncommon to have on-screen response to inputs lag by several frames (refresh periods).

### BRIEF SUMMARY

In summary, one aspect provides a method, comprising: providing an indication of display screen refresh timing derived from a display system; associating, using the indication of the display screen refresh timing, a set of input data derived from an input surface with a display screen refresh interval; and synchronizing, using one or more processors, the set of input data derived from the input surface with a refresh of a display screen.

Another aspect provides an information handling device, comprising: an input surface; a display system; one or more processors; a memory device assessable to the one or more processors and storing code executable by the one or more processors to: provide an indication of display screen refresh timing derived from a display system; associate, using the indication of the display screen refresh timing, a set of input data derived from an input surface with a display screen refresh interval; and synchronize, using one or more processors, the set of input data derived from the input surface with a refresh of a display screen.

A further aspect provides a program product, comprising: a storage device having computer readable program code stored therewith, the computer readable program code comprising: computer readable program code configured to provide an indication of display screen refresh timing derived from a display system; computer readable program code configured to associate, using the indication of the display screen refresh timing, a set of input data derived from an input surface with a display screen refresh interval; and computer readable program code configured to synchronize, using one or more processors, the set of input data derived from the input surface with a refresh of a display screen.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example of synchronization of input surface data and display screen refresh.

FIG. 4 illustrates an example information handling device having components for synchronization of input surface data and display screen refresh.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Many input surfaces (e.g., digitizer, touch screen, etc.) function as a sensor that delivers data at one point in time, i.e., as input data is sensed it is streamed or reported to another component or system, e.g., an operating system (OS). This minimizes delay latency in the input data delivery but also incurs a high expense of having the input surface provide many interrupts, each transferring only a small amount of data. One possible result is greater end-to-end latency as the system processor/CPU receives each data point and adds it to a buffer to be processed when the OS is ready for the data.

I/O architecture (e.g., USB, I2C, etc.) is evolving to adopt a batch-processing methodology. Thus, input surfaces fill an internal buffer and release data on-demand as a batch or group of data points that have been collected during an interval. This is generally more efficient in terms of interrupt handling but introduces a new problem, i.e., the data in the buffer(s) is likely to straddle two display frames (refresh periods), part from one frame and part from another. The system (OS) simply requests/receives a batch of data points collected since the last request and no attempt is made to take into account the relationship between the location data points and the display screen functioning (e.g., frame or refresh rate). This leads to difficulties in certain contexts. For example, if the user is providing input rapidly (e.g., moving a stylus around quickly, such as when providing handwriting input), the resultant visual display may be a “jumpy” drawing characteristic rendered by the display screen. For example, a line drawn on screen by a user may be rendered such that it falls behind the stylus tip and then catches up abruptly.

Accordingly, an embodiment provides a solution wherein input surface data (e.g., derived from an input to a digitizer or touch screen) is synchronized with a screen refresh timing. An embodiment utilizes an indication of the display screen refresh timing, e.g., the vsync signal signal available from a graphics sub-system. This provides data from the input surface to the system (e.g., OS) and applications thereof in a timely fashion such that on screen renderings are improved by virtue of including in the overall synchronization the data of the input sub-system.

The illustrated example embodiments will be best understood by reference to the figures. The following description is intended only by way of example, and simply illustrates certain example embodiments.

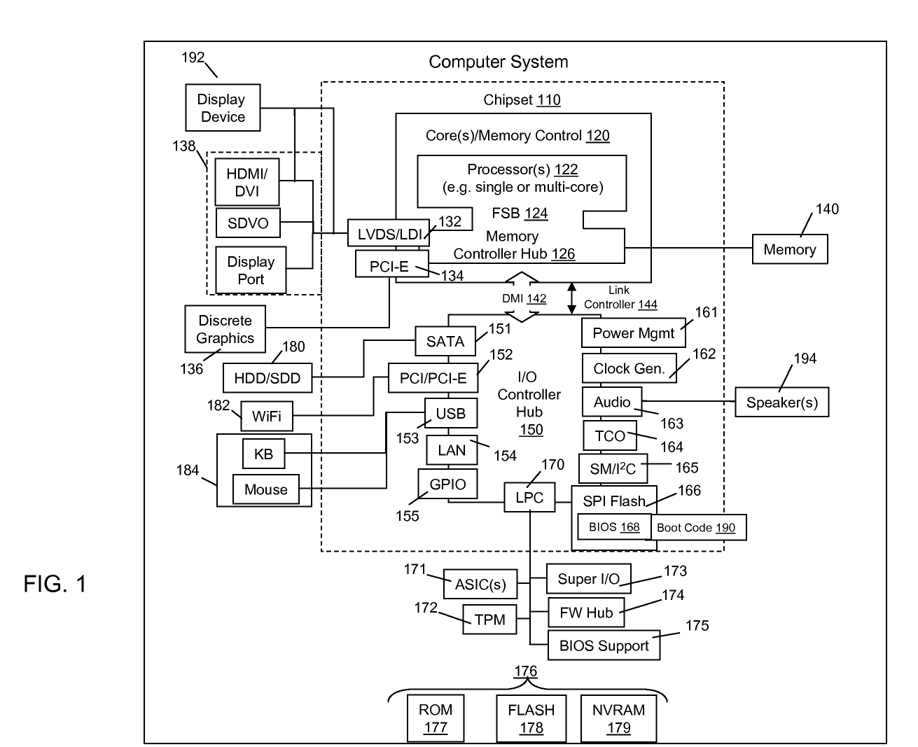

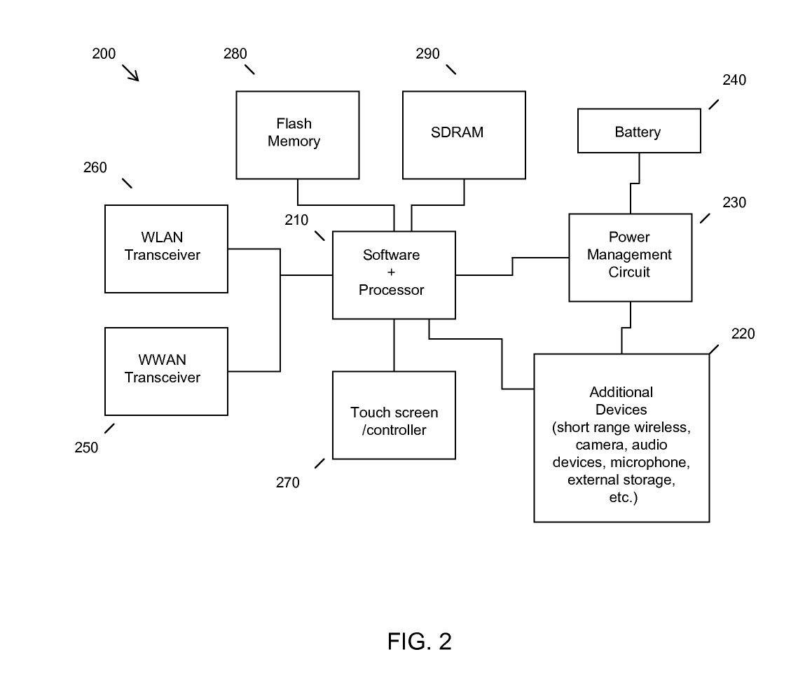

Referring to FIG. 1 and FIG. 2, while various other circuits, circuitry or components may be utilized in information handling devices, with regard to smart phone and/or tablet circuitry 200, an example illustrated in FIG. 2 includes a system on a chip design found for example in tablet or other mobile computing platforms. Software and processor(s) are combined in a single chip 210. Internal busses and the like depend on different vendors, but essentially all the peripheral devices (220) may attach to a single chip 210. In contrast to the circuitry illustrated in FIG. 1, the circuitry 200 combines the processor, memory control, and I/O controller hub all into a single chip 210. Also, system 200 of this type do not typically use SATA or PCI or LPC. Common interfaces for example include SDIO and I2C.

There are power management chip(s) 230, e.g., a battery management unit, BMU, which manage power as supplied for example via a rechargeable battery 240, which may be recharged by a connection to a power source (not shown). In at least one design, a single chip, such as 210, is used to supply BIOS like functionality and DRAM memory.

System 200 typically includes one or more of a WWAN transceiver 250 and a WLAN transceiver 260 for connecting to various networks, such as telecommunications networks and wireless base stations. Commonly, system 200 will include a touch screen 270 for data input and display. System 200 also typically includes various memory devices, for example flash memory 280 and SDRAM 290.

FIG. 1, for its part, depicts a block diagram of another example of information handling device circuits, circuitry or components. The example depicted in FIG. 1 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 1.

The example of FIG. 1 includes a so-called chipset 110 (a group of integrated circuits, or chips, that work together, chipsets) with an architecture that may vary depending on manufacturer (for example, INTEL, AMD, ARM, etc.). The architecture of the chipset 110 includes a core and memory control group 120 and an I/O controller hub 150 that exchanges information (for example, data, signals, commands, et cetera) via a direct management interface (DMI) 142 or a link controller 144. In FIG. 1, the DMI 142 is a chip-to-chip interface (sometimes referred to as being a link between a “northbridge” and a “southbridge”). The core and memory control group 120 include one or more processors 122 (for example, single or multi-core) and a memory controller hub 126 that exchange information via a front side bus (FSB) 124; noting that components of the group 120 may be integrated in a chip that supplants the conventional “northbridge” style architecture.

In FIG. 1, the memory controller hub 126 interfaces with memory 140 (for example, to provide support for a type of RAM that may be referred to as “system memory” or “memory”). The memory controller hub 126 further includes a LVDS interface 132 for a display device 192 (for example, a CRT, a flat panel, touch screen, et cetera). A block 138 includes some technologies that may be supported via the LVDS interface 132 (for example, serial digital video, HDMI/DVI, display port). The memory controller hub 126 also includes a PCI-express interface (PCI-E) 134 that may support discrete graphics 136.

In FIG. 1, the I/O hub controller 150 includes a SATA interface 151 (for example, for HDDs, SDDs, 180 et cetera), a PCI-E interface 152 (for example, for wireless connections 182), a USB interface 153 (for example, for devices 184 such as a digitizer, keyboard, mice, cameras, phones, microphones, storage, other connected devices, et cetera), a network interface 154 (for example, LAN), a GPIO interface 155, a LPC interface 170 (for ASICs 171, a TPM 172, a super I/O 173, a firmware hub 174, BIOS support 175 as well as various types of memory 176 such as ROM 177, Flash 178, and NVRAM 179), a power management interface 161, a clock generator interface 162, an audio interface 163 (for example, for speakers 194), a TCO interface 164, a system management bus interface 165, and SPI Flash 166, which can include BIOS 168 and boot code 190. The I/O hub controller 150 may include gigabit Ethernet support.

The system, upon power on, may be configured to execute boot code 190 for the BIOS 168, as stored within the SPI Flash 166, and thereafter processes data under the control of one or more operating systems and application software (for example, stored in system memory 140). An operating system may be stored in any of a variety of locations and accessed, for example, according to instructions of the BIOS 168. As described herein, a device may include fewer or more features than shown in the system of FIG. 1.

Information handling devices, as for example outlined in FIG. 1 and FIG. 2, may provide input surfaces (e.g., digitizer, touch screen or the like) that allow a user to provide input (e.g., touch input via a finger tip or stylus, etc.) and have renderings on screen in response to such inputs. A common example of such rendering and response is providing handwriting input to a touch screen or digitizer with a stylus that is in turn rendered on the display screen as handwritten input.

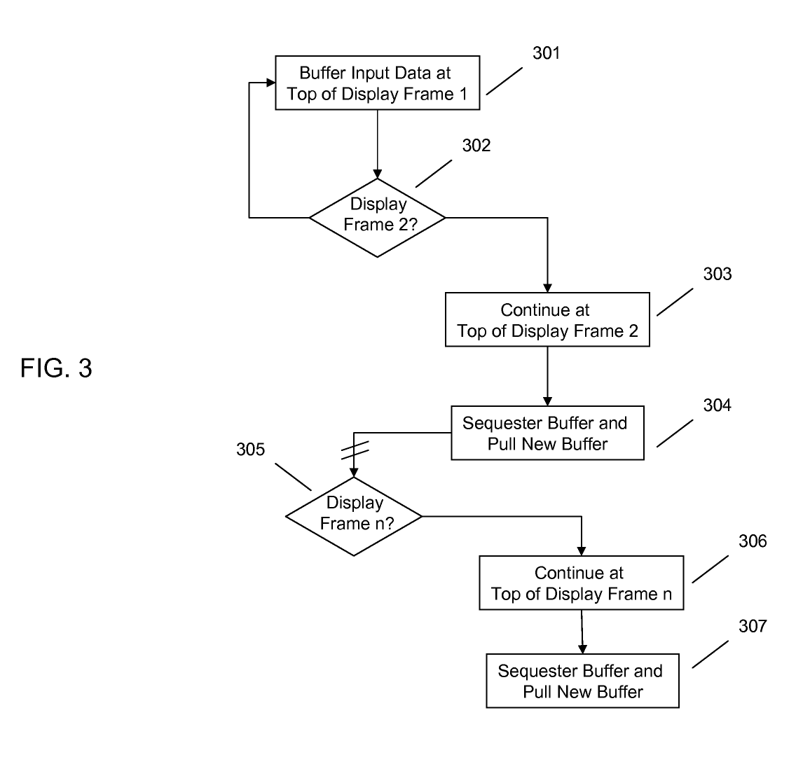

Referring to FIG. 3, an input surface, e.g., digitizer, may buffer input data (i.e., input data corresponding to x, y coordinate data of inputs from a stylus) at the top or beginning of a first display frame refresh at 301. The digitizer continues to buffer the input data, e.g., until the top of a next or second display frame, i.e., corresponding to the beginning of a screen refresh on the display is detected at 302.

Thus, at a predetermined point in time, a determination is made 302, e.g., a determination that a top of a next display frame (such as 2^{nd} frame) is detected. This causes the digitizer to buffer the remaining input data for the current display frame 303 and to sequester the current buffer 304 until the system (e.g., OS) requests the data from the digitizer sub-system. Also, the digitizer will make available another buffer 304 continue to buffer the input data (storing the input data into another buffer), e.g., selected from a pool of available buffers. An embodiment proceeds in this manner such that when the top of an n^{th} frame is detected 305, an n^{th} buffer is created 306 and sequestration/availing a new buffer continue 307 in like fashion. This permits sequestering input data into buffers, and subsequent release thereof to an OS, utilizing timing information of the display screen's refresh. The buffer pool or storage space needs to contain enough space to buffer input data to cover a worst-case scenario, i.e., input data corresponding to a number of frames the OS may (temporarily) fall behind such that this data is available when the OS is capable of handling it.

Other mechanisms for leveraging the indication of display screen refresh rate or timing are possible. For example, in addition to such buffering, or as an alternative thereto, an embodiment may provide timing information along with the input data derived form the input sub-system. Thus, another component, e.g., an OS of the overall system, may be able to sort through the input data and utilize appropriately synchronized input data based on knowledge of the display screen refresh rate. Thus, an input sub-system need not be explicitly notified or made aware of the display screen refresh timing. Moreover, an OS may be modified to appropriately time requests such that input data buffered by an input sub-system is appropriately synchronized with the display screen refresh timing.

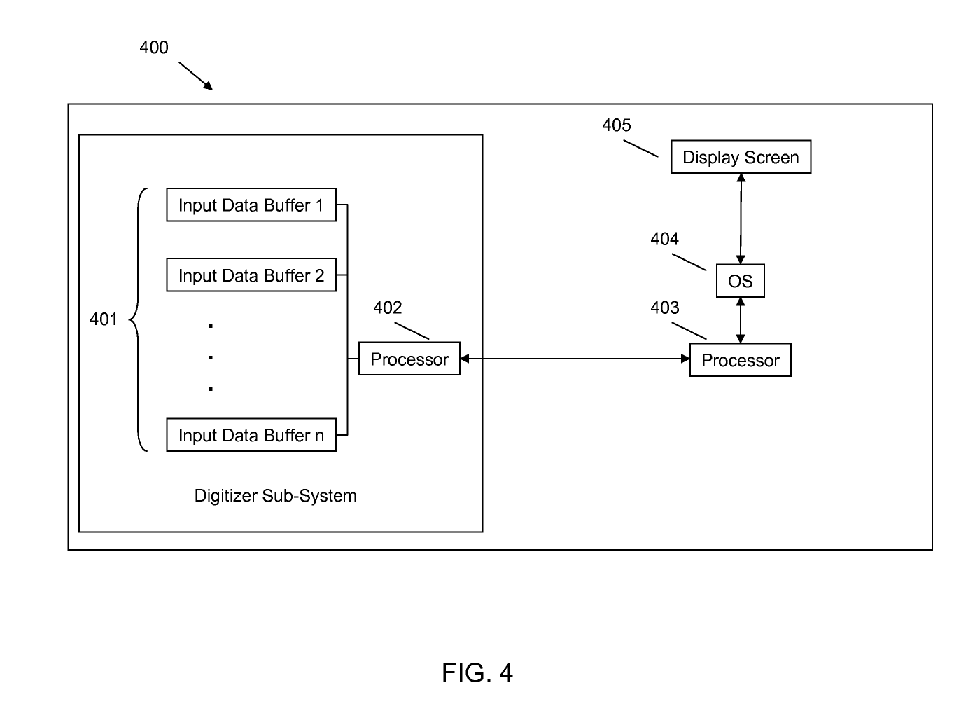

Referring to FIG. 4, in the example case of buffering the input data, an input sub-system such as a digitizer incorporated in an information handling device 400 (e.g., a laptop computer) may include a plurality of buffers 401. It should be noted that although separate buffers are illustrated in the group or plurality of buffers 401, these may be logical or physical distinctions.

A controller of the input sub-system, including e.g., including a processor 402, may provide input data to a processor 403 of system 400, e.g., for use in an OS 404 operating a display 405 (noting that display 405 may include its own sub-system, e.g., graphics sub-system). Likewise, as further described herein, OS 404 may avail input sub-system processor 402 with information or indication regarding the timing of display screen 405 refresh/frame rate. For example, processor 403 may communicate this information to processor 402, which in turn manages the input data buffering in buffers 401 such that it is appropriately synchronized with the display device 405 timing.

A digitizer sub-system (as a non-limiting example of an input sub-system) may detect or be apprised of the beginning of a new display frame of a display device 405 through several mechanisms. For example, a graphics sub-system generally makes available or provides a “vsync” (vertical synchronization) interrupt to the OS 404 at the bottom or end of a display frame. In reaction to this, the OS 404 may explicitly notify the processor 402 of the digitizer or input sub-system in question of the end of or impending beginning of a display frame.

As another example, an additional vsync signal line (not illustrated) may be routed directly to a new start of frame input on the input sub-system to inform, e.g., a processor 403 of a digitizer, of the start or top of a new display frame. Therefore, the vsync signal may be utilized to indicate the synchronization timing between the display screen 405 frame refresh and collected input data stored in buffers 401.

In an example case where the input sub-system is closely integrated with the display screen 405 (e.g., a touch screen sub-system), the existing vsync signal utilized by the touch screen control may be borrowed from the display screen 405 and routed to the digitizer or touch screen sub-system. This is akin to having the OS 404 notify the digitizer or touch screen sub-system, but takes advantage of the locality of the components of the touch screen sub-system. For example, as all components of the touch screen/digitizer may be located in the same functional block, such an approach may be particularly appropriate for in-cell touch input device designs.

Other possible mechanisms of obtaining synchronization information are possible. For example, current digitizer and touch screen implementations attempt to cancel out interference between display scanning and digitizer scanning In order to do this (e.g., off-set the display scan and the digitizer scan), the sub-system is aware of the display refresh or frame beginning point or timing (e.g., vsync signal interval). In an embodiment, the detected vsync signal interval or timing may be used, in addition to preventing scan interference, to indicate when the display begins a new frame in order to appropriately buffer and provide input data to the display for refresh.

A benefit of determining the precise timing of the display scan position allows an input sub-system to more efficiently cancel out interference that display scanning creates. For example, an input sub-system may scan its own array slightly ahead of or behind the display scan, etc., because the display scan position is known. This would permit off-set between the two scans (display and input) and consequently avoidance of interference there-between.

Processing of the input data may be appropriately scaled or tailored using such timing information regarding display screen refresh or scanning During the time that the input sub-system controller (including processor 402) is accumulating input samples in buffers 401 and, e.g., in between vsync boundaries, the input sub-system controller may apply additional processing or filtering of the input data. In contrast to conventional filtering processes that may not be completed prior to the next request, and thus delay delivery of data, e.g., to OS 404, an embodiment, having timing information regarding display refresh rate available (e.g., by virtue of knowing the vsync signal interval), may appropriately scale processing so as to not delay delivery of buffered input data. For example, the input sub-system controller sub-system may use the collection of samples to filter out errant data points or to apply signal processing to improve the accuracy or quality of the collection of samples during the buffering interval. Such processing may include but not necessarily be limited to improved line drawing routines such as smoothing and straightening, improved character formation, assisted handwriting recognition pre-processing and shape or region drawing assistance.

The input sub-system controller may alter its sampling frequency from one vsync period to the next. In this fashion, the amount of activity within the current vsync period can be used to predict the appropriate sampling frequency of the next period. The per-vsync period frequency adjustment would allow the input sub-system controller to trade off sampling resolution for power consumption based on the content of the previous interval or period.

By combining increased sample frequency and additional signal processing within the input sub-system controller, the accuracy of the input device can be improved. This may be accomplished using samples for the same data input position and then averaging them together to register an (x, y) point with greater accuracy. This concept may be extended to a line segment, where each (x, y) point may use the previous series of points to more accurately register the current position.

Accordingly, an embodiment provides synchronization between input data provisioning, e.g., via appropriate buffering/delivery of input data within a data input sub-system, and display screen refresh/frame rate. Such appropriate synchronization will help a system avoid unfortunate visual artifacts (e.g., delayed rendering, tearing, etc.) from occurring due to out-of-synch input data and display screen data.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
providing an indication of display screen refresh timing derived from a display system;
associating, using the indication of the display screen refresh timing, a set of input data derived from an input surface with a display screen refresh interval; and
synchronizing, using one or more processors, the set of input data derived from the input surface with a refresh of a display screen.

2. The method of claim 1, wherein said providing comprises communicating the indication of display screen refresh timing between an operating system and the input surface.

3. The method of claim 1, wherein said providing comprises providing a line communicating the indication of display screen refresh timing between the display system and the input surface.

4. The method of claim 1, wherein associating a set of input data derived from the input surface with a display screen refresh interval comprises utilizing one or more buffers to buffer a set of input data derived from the input surface.

5. The method of claim 4, wherein the one or more buffers buffer a set of input data derived from the input surface during a display screen refresh interval.

6. The method of claim 1, wherein the indication of the display screen refresh timing comprises an event associated with a vsync signal.

7. The method of claim 6, wherein the vsync signal is derived from a graphics sub-system.

8. The method of claim 1, wherein associating comprises utilizing timing information of buffered input data derived from the input surface to select the set of input data.

9. The method of claim 1, further comprising processing input data derived from the input surface during a display screen refresh interval.

10. The method of claim 9, wherein the processing of the input data derived from the input surface is scaled based on the display screen refresh interval.

11. An information handling device, comprising:
an input surface;
a display system;
one or more processors;
a memory device assessable to the one or more processors and storing code executable by the one or more processors to:
provide an indication of display screen refresh timing derived from a display system;
associate, using the indication of the display screen refresh timing, a set of input data derived from an input surface with a display screen refresh interval; and
synchronize, using one or more processors, the set of input data derived from the input surface with a refresh of a display screen.

12. The information handling device of claim 11, wherein to provide comprises communicating the indication of display screen refresh timing between an operating system and the input surface.

13. The information handling device of claim 11, wherein to provide comprises providing a line communicating the indication of display screen refresh timing between the display system and the input surface.

14. The information handling device of claim 11, wherein to associate a set of input data derived from the input surface with a display screen refresh interval comprises utilizing one or more buffers to buffer a set of input data derived from the input surface.

15. The information handling device of claim 14, wherein the one or more buffers buffer a set of input data derived from the input surface during a display screen refresh interval.

16. The information handling device of claim 11, wherein the indication of the display screen refresh timing comprises an event associated with a vsync signal.

17. The information handling device of claim 16, wherein the vsync signal is derived from a graphics sub-system.

18. The information handling device of claim 11, wherein to associate comprises utilizing timing information of buffered input data derived from the input surface to select the set of input data.

19. The information handling device of claim 11, wherein the code is further executable by the one or more processors to process input data derived from the input surface during a display screen refresh interval, wherein processing of the input data derived from the input surface is scaled based on the display screen refresh interval.

20. A program product, comprising:
a storage device having computer readable program code stored therewith, the computer readable program code comprising:
computer readable program code configured to provide an indication of display screen refresh timing derived from a display system;
computer readable program code configured to associate, using the indication of the display screen refresh timing, a set of input data derived from an input surface with a display screen refresh interval; and
computer readable program code configured to synchronize, using one or more processors, the set of input data derived from the input surface with a refresh of a display screen.
